(19) United States
(12) Patent Application Publication
(10) Pub. No.: US 2008/0060252 A1
(43) Pub. Date: Mar. 13, 2008

(54) STEALTH SINKER

(76) Inventor: David N. Doss, Gulfport, FL (US)

Correspondence Address: LARSON AND LARSON, 11199 69TH STREET NORTH, LARGO, FL, 33773, US

(21) Appl. No.: 11/530,700

(22) Filed: Sep. 11, 2006

(51) Int. Cl. A01K 95/00

(52) U.S. Cl. 43/43.1; 43/44.87; 43/42.32; 43/42.33

(57) ABSTRACT

A stealth sinker is disclosed including a body member having a specific gravity greater than 1 and made from a material that reduces visibility to a target fish. A device for attaching a fishing line to the body member is also provided. The material is colored glass, lead crystal glass, colored lead crystal glass or a dense material coated with a reflective surface.

### BACKGROUND OF THE INVENTION

1. Field of the Invention

This invention relates to the field of weights or sinkers and more particularly to a weight or sinker for fishing lines or nets.

2. Description of the Related Art

The majority of sinkers in use by fisherman today are made from metal formed in a mold. The most common metal used is lead and although it is still used today, other metals are replacing it because lead can be toxic. In many areas, lead is not allowed because of its effect on the environment and wildlife. In its place, brass, tungsten, steel, and bismuth have been used in sinkers and weights.

There are many types and shapes of sinkers including:
Split shot sinkers featuring a groove that runs the full length of the sinker for holding the fishing line.
Rubber core sinkers that resemble split shot sinkers but have a rubber grip in their center to hold the fishing line.
Bell sinkers that resemble a tear-drop with an eye at their top for attaching a fishing line.
Pyramid sinkers that are in the shape of an inverted pyramid with an eye at the base (top) for attaching a fishing line.
Bank or reef sinkers that are egg shaped with hexagonal flat sides to prevent rolling in strong currents.
Walking Sinker that are rectangular with rounded edges and an eye on top for attaching a fishing line.
Egg sinkers are egg-shape making them fairly snag resistant and able to roll along the bottom. The fishing line is threaded through a hole that runs lengthwise though the sinkers.
Cone sinkers and bullet shots are similar to the egg sinkers in that they are threaded onto the line with their narrow point facing towards the rod. The cone-shape of these sinkers reduces weed build-up.

In all, different shapes of weights or sinkers serve different purposes, but the prior art does not address appearance to the fish. When a fish sees the sinker in the vicinity of the bait, the fish is often hesitant to take the bait. One solution to this is described in U.S. Pat. No. 5,377,433 to Giray. This patent describes a glass fishing weight or sinker. It goes on to say that the glass sinker is transparent or translucent and therefore does not disturb or alarm the fish. The main issue with glass is its specific gravity. The ability to sink a fishing rig and fishing line depends upon its specific gravity (SG) with respect to the fishing rig and fishing line. Specific gravity is defined as the ratio of the density of a material compared to the density of pure water. Since the density of pure water varies with temperature, the temperature standard is at 3.98° C. (39.2° F.). At that temperature, the density of pure water is 1.0000 g/cm3.

Depending upon the water temperature and impurities, an object with a specific gravity of less than 1 will generally float and greater than 1 will generally sink. With respect to fishing, fishing line is made from materials such as Dacron, polyester and nylon and all have a specific gravity of less than 1. Therefore, the sinker must have an specific gravity significantly greater than 1 in order to pull the fishing line, hook and bait into the depths of water where the fish are located.

A sinker made entirely of lead has an specific gravity of approximately 11.34. This is why fishing sinkers have long been made from lead. A sinker made entirely from glass has an specific gravity of from 2.4 to 2.8 and will function to carry an amount of fishing line into the depths but the overall average specific gravity will determine how much fishing line can be pulled under by a given sinker. The fishing line will tend to float because of its low specific gravity and the sinker will need to counterbalance this by having a higher specific gravity.

What is needed is a sinker that is difficult for a fish to see and has an improved specific gravity allowing it to sink a useful amount of fishing line, tackle and bait.

### SUMMARY OF THE INVENTION

It is an objective of the present invention to provide a fishing sinker that is difficult for a fish to see when submerged in water.

It is another objective of the present invention to provide a fishing sinker that has a high specific gravity, allowing it to perform well in salt or fresh water at many depths.

It is another objective of the present invention to provide a fishing sinker that reduces impact on the environment.

In one embodiment, a stealth sinker is disclosed including a body member having a specific gravity greater than 1 and is made from a material that reduces visibility to a target fish. A device for attaching a fishing line to the body member is also provided.

In another embodiment, a stealth sinker is disclosed including a body member made from lead crystal glass, the lead crystal glass reduces visibility of the body member to a target fish. A device for attaching a fishing line to the body member is also provided.

In another embodiment, a stealth sinker is disclosed including a body member having a core material and a reflective coating whereas the core material has a specific gravity greater than 1 and the coating reduces visibility to a target fish. A device for attaching a fishing line to the body member is also provided.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates an egg-shaped sinker of the prior art.

FIG. 2 illustrates a sinker of the prior art.

FIG. 3 illustrates a tear-drop sinker of the prior art.

FIG. 4 illustrates a pyramid sinker of the prior art.

FIG. 5 illustrates an egg-shaped sinker of a first embodiment of the present invention.

FIG. 6 illustrates an egg-shaped sinker of a second embodiment of the present invention.

FIG. 7 illustrates a sinker of a first embodiment of the present invention.

FIG. 8 illustrates a sinker of a second embodiment of the present invention.

FIG. 9 illustrates a tear-drop sinker of a first embodiment of the present invention.

FIG. 10 illustrates a tear-drop sinker of a second embodiment of the present invention.

FIG. 11 illustrates a pyramid sinker of a first embodiment of the present invention.

FIG. 12 illustrates a pyramid sinker of a second embodiment of the present invention.

FIG. 13 illustrates a pyramid sinker of a third embodiment of the present invention.

FIG. 14 illustrates a sinker of the prior art in use.

FIG. 15 illustrates a sinker of the present invention in use.

FIG. 16 illustrates a sinker of the second embodiment of the present invention in use.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

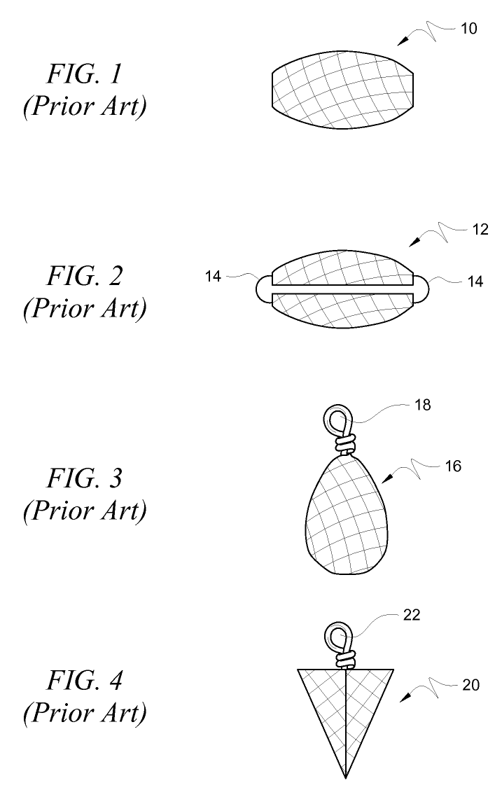

Referring to FIG. 1, an egg-shaped sinker of the prior art is shown. The egg-shaped sinker 10 has a hole through its axis to accept a fishing line (not shown). In the prior art, most sinkers are made from metal such as lead. Lead having a specific gravity of 11.34 is ideal for casting and submerging the fishing line, but as discussed previously, lead is harmful to the environment. Furthermore, a metal sinker is easily visible to the target fish and often scares the fish from taking the bait.

Referring to FIG. 2, a sinker of the prior art is shown. The sinker 12 has two eyelets 14 for accept a fishing line. As with the egg-shaped sinker of the prior art, most of these sinkers are also made from metal such as lead. Lead having a specific gravity of 11.34 is ideal for casting and submerging the fishing line, but as discussed previously, lead is harmful to the environment. Furthermore, a metal sinker is easily visible to the target fish and often scares the fish from taking the bait.

Referring to FIG. 3, a tear-drop sinker of the prior art is shown. The tear-drop sinker 16 has an eye 18 for accepting a fishing line. As with the previous sinkers of the prior art, most of these sinkers are also made from metal such as lead. Lead having a specific gravity of 11.34 is ideal for casting and submerging the fishing line, but as discussed previously, lead is harmful to the environment. Furthermore, a metal sinker is easily visible to the target fish and often scares the fish from taking the bait.

Referring to FIG. 4, a pyramid sinker of the prior art is shown. The pyramid sinker 20 has an eyelet 22 for accepting a fishing line. As with the prior sinkers of the prior art, most of these sinkers are also made from metal such as lead. Lead having a specific gravity of 11.34 is ideal for casting and submerging the fishing line, but as discussed previously, lead is harmful to the environment. Furthermore, a metal sinker is easily visible to the target fish and often scares the fish from taking the bait.

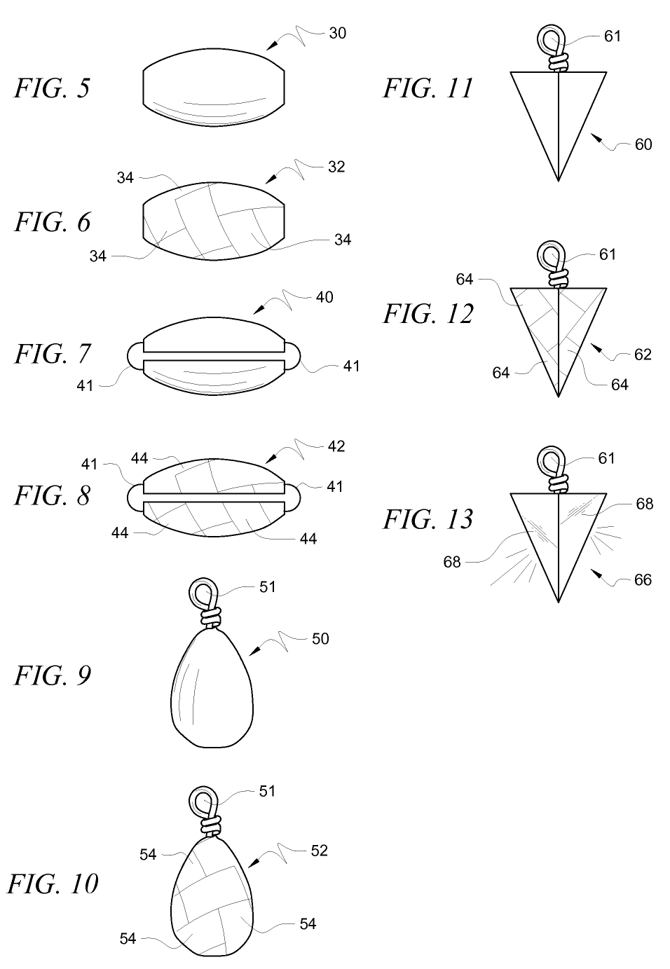

Referring to FIG. 5, an egg-shaped sinker of a first embodiment of the present invention is shown. This egg shaped sinker 30 is made from glass or lead crystal glass that, in some embodiments, is colored to make it less visible at the target depth and water conditions. Lead crystal has been in existence since the second half of the 17th century. English glassmaker George Ravenscroft discovered lead crystal while searching for a way to improve the luster and clarity of his glassware. He found that by adding lead oxide to molten glass he could not only improve the clarity of the glass but dramatically increase the weight (hence specific gravity), the index of refraction and the ability to cut the material.

Lead crystal glass is preferred since it has a specific gravity of 2.9 to 3, whereas, glass has a specific gravity of 2.4 to 2.8. The glass is colored by adding a material to the molten glass before forming the molten glass into the sinker. Different colors are selected based upon the environment where the sinker is to be used. For example, a brown hue is used for darker waters while a pink hue is used at greater depths where the sunlight is low. Table 1 shows an exemplary list of materials and the resulting glass colors.

TABLE 1
Glass Color Additive Chart

```
Iron oxide: bluish-green color
Sulfur, together with carbon and iron
    salts: amber color
Manganese: amethyst or purple color
Selenium: reddish color
Cobalt: blue color
Cobalt with boro-silicate: pink color
Copper oxide: turquoise color
Metallic copper: very dark red
Nickel: blue, purple or black color
Chromium: dark green color
Cadmium together with sulfur: deep yellow
    color
Titanium: yellowish-brown glass
Metallic gold: ruby or red color glass
Uranium: fluorescent yellow or green color
Silver compounds (e.g., silver nitrate):
    brown, orange-red, yellow
```

Referring to FIG. 6, an egg-shaped sinker of a second embodiment of the present invention is shown. The egg-shaped sinker 32 is made from lead crystal glass that, in some embodiments, is colored to make it less visible at the target depth and water conditions. In this embodiment, the lead crystal sinker 32 has facets 34 for reflecting light in various directions. In some embodiments, the sinker 32 is made from colored lead crystal as in FIG. 5.

Referring to FIG. 7, a sinker of a first embodiment of the present invention is shown. This sinker 40 is made from glass or lead crystal glass that, in some embodiments, is colored to make it less visible at the target depth and water conditions. Lead crystal glass is preferred since it has a specific gravity of 2.9 to 3, whereas, glass has a specific gravity of 2.4 to 2.8. The glass is colored by adding a material to the molten glass before forming the molten glass into the sinker as shown in Table-1. Eyelets 41 are provided for attaching a fishing line.

Referring to FIG. 8, a sinker of a second embodiment of the present invention is shown. The sinker 42 is made from lead crystal glass that, in some embodiments, is colored to make it less visible at the target depth and water conditions. In this embodiment, the lead crystal sinker 42 has facets 44 for reflecting light in various directions. In some embodiments, the sinker 42 is made from colored lead crystal as in the previous embodiment. Eyelets 41 are provided for attaching a fishing line.

Referring to FIG. 9, a tear-drop sinker of a first embodiment of the present invention is shown. This tear-drop shaped sinker 50 is made from glass or lead crystal glass that, in some embodiments, is colored to make it less visible at the target depth and water conditions. Lead crystal glass is preferred since it has a specific gravity of 2.9 to 3, whereas, glass has a specific gravity of 2.4 to 2.8. The glass is colored by adding a material to the molten glass before forming the molten glass into the sinker as shown in Table-1. An eye 51 is provided for attaching a fishing line.

Referring to FIG. 10, a tear-drop sinker of a second embodiment of the present invention is shown. The tear-drop shaped sinker 52 is made from lead crystal glass that, in some embodiments, is colored to make it less visible at the target depth and water conditions. In this embodiment, the lead crystal sinker 52 has facets 54 for reflecting light in various directions. In some embodiments, the sinker 52 is made from colored lead crystal as in the previous embodiment. An eye 51 is provided for attaching a fishing line.

Referring to FIG. 11, a pyramid sinker of a first embodiment of the present invention is shown. This pyramid shaped sinker 60 is made from glass or lead crystal glass that, in some embodiments, is colored to make it less visible at the target depth and water conditions. Lead crystal glass is preferred since it has a specific gravity of 2.9 to 3, whereas, glass has a specific gravity of 2.4 to 2.8. The glass is colored by adding a material to the molten glass before forming the molten glass into the sinker as shown in Table-1. An eye 61 is provided for attaching a fishing line.

Referring to FIG. 12, a pyramid sinker of a second embodiment of the present invention is shown. The pyramid shaped sinker 62 is made from lead crystal glass that, in some embodiments, is colored to make it less visible at the target depth and water conditions. In this embodiment, the lead crystal sinker 62 has facets 64 for reflecting light in various directions. In some embodiments, the sinker 62 is made from colored lead crystal as in the previous embodiment. An eye 61 is provided for attaching a fishing line.

Referring to FIG. 13, a pyramid sinker of a third embodiment of the present invention is shown. The pyramid sinker 66 is made from a core material that has a specific gravity of greater than 1 such as copper, steel, iron or rock (natural or concrete). In this embodiment, the outside of the sinker is coated with a mirror surface 68 by painting, electroplating or covering with a mirror-like material. Since the sinker of this embodiment is coated and the coating can be a non-toxic material, the core material can be lead since it will not be exposed to the environment. An eye 61 is provided for attaching a fishing line.

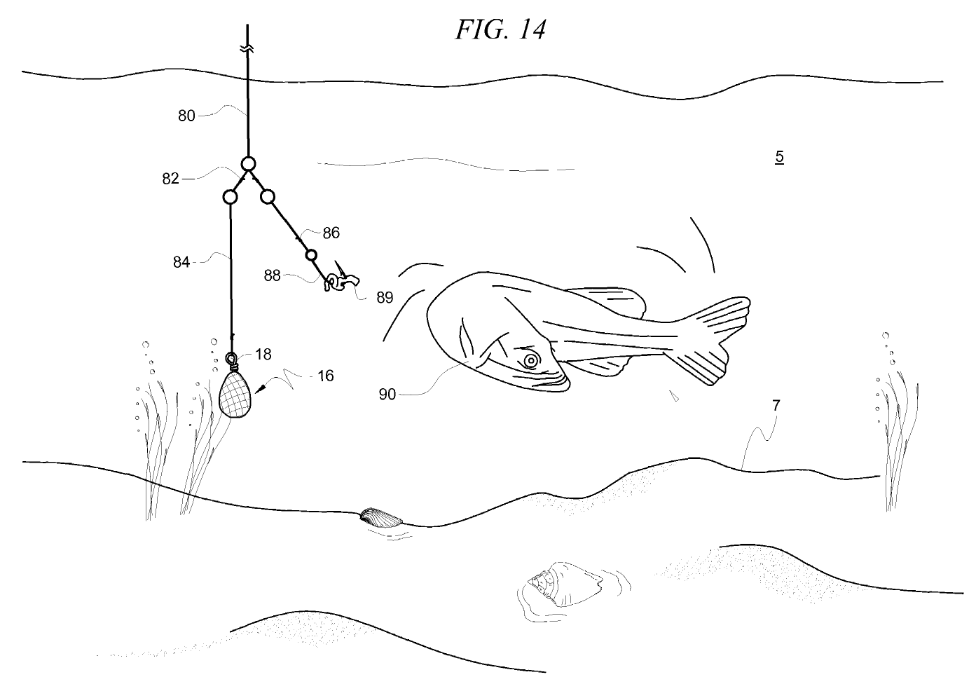

Referring to FIG. 14, a sinker of the prior art in use is shown. The tear-drop sinker 16 of the prior art has an eye 18 for attaching a fishing line 84. As with the previous sinkers of the prior art, most of these sinkers are also made from metal such as lead. Lead having a specific gravity of 11.34 is ideal for casting and submerging the fishing line, but as discussed previously, lead is harmful to the environment. In use, the fishing line 84 is tied to the eye 18 of the sinker 16, connecting the sinker 16 to a swivel 82. After casting, the sinker submerges in the water 5, resting on the bottom surface 7. The swivel is also connected to a second fishing line 80 that reaches to a fishing pole (not shown). Another fishing line 86 connects the swivel to the hook 88. Presumably, bait 89 on the hook 88 is eaten by the fish 90 and the fish is caught on the barb of the hook 88 and brought to the surface. Unfortunately, since the metal sinker 16 of the prior art is easily visible to the target fish 90, the target fish becomes weary and decides not to take the bait 89.

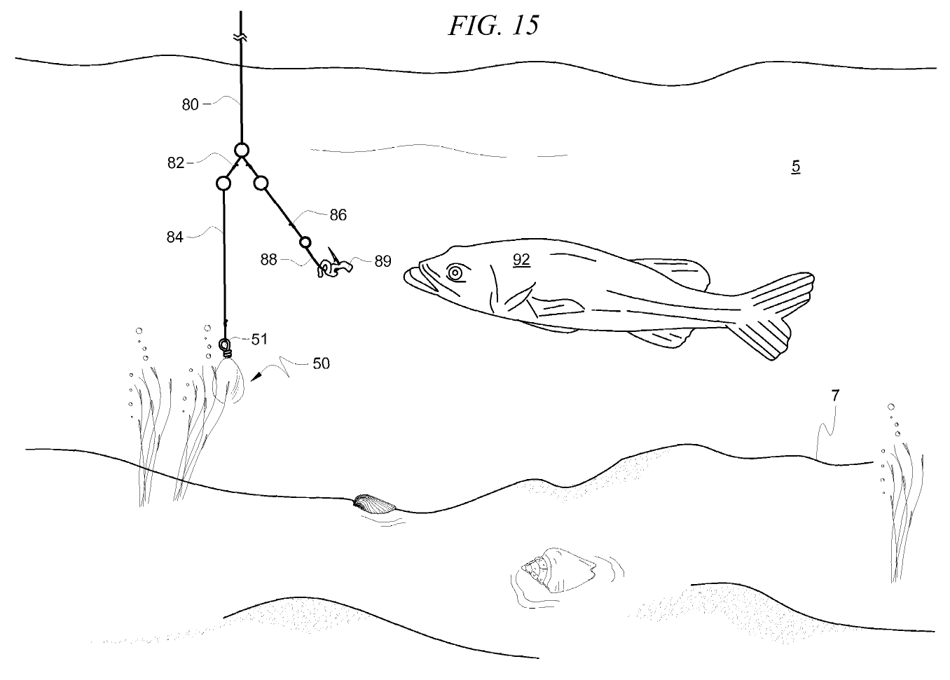

Referring to FIG. 15, a sinker of the present invention in use is shown. As with the above described sinkers of the present invention, the sinker 50 is less visible to a fish than sinkers of the prior art. The sinker 50 is made of lead-crystal glass, but in other embodiments is made from colored glass, colored lead crystal glass or from a material with a high specific gravity such as steel, iron, lead or stone and coated with a reflective, mirror-like surface. In use, the fishing line 84 is tied to the eye 51 of the sinker 50, connecting the sinker 50 to a swivel 82. After casting, the sinker 50 submerges in the water 5, resting on the bottom surface 7. The swivel is also connected to a second fishing line 80 that reaches to a fishing pole (not shown). Another fishing line 86 connects the swivel to the hook 88. Presumably, bait 89 on the hook 88 is eaten by the fish 92 and the fish is caught on the barb of the hook 88 and brought to the surface. Since the sinker 50 is virtually invisible to the target fish 92, the target fish is not frightened by the sinker and decides to take the bait 89 and is hence caught.

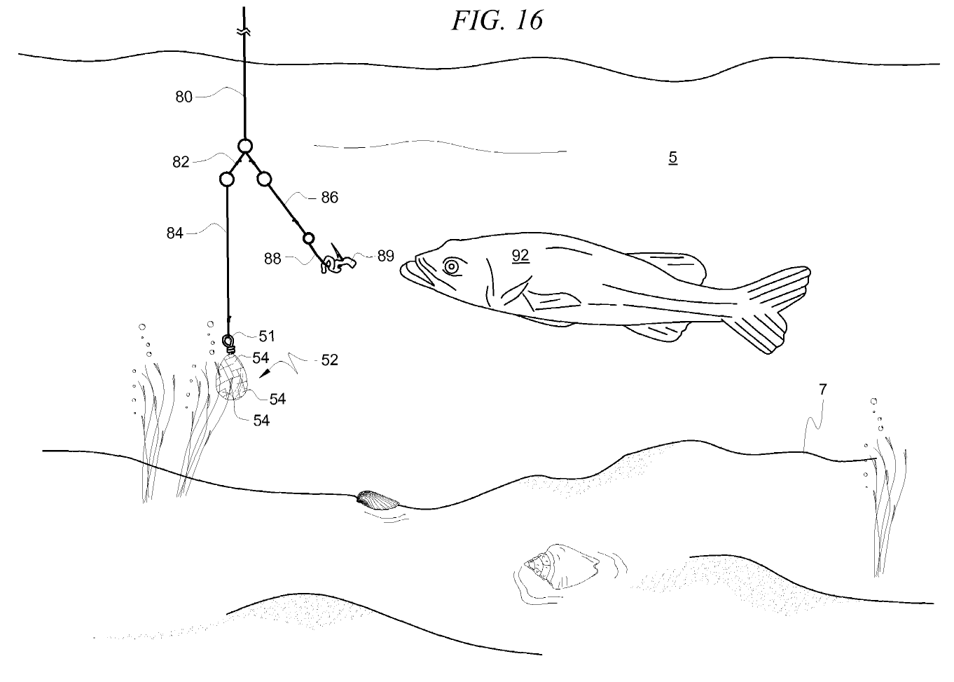

Referring to FIG. 16, a sinker of the second embodiment of the present invention in use is shown. As with the above described sinkers of the present invention, the sinker 52 is less visible to a fish than sinkers of the prior art due to reflections of its facets 54. The sinker 52 is made of lead-crystal glass, but in other embodiments is made from colored lead crystal glass. In use, the fishing line 84 is tied to the eye 51 of the sinker 52, connecting the sinker 52 to a swivel 82. After casting, the sinker 52 submerges in the water 5, resting on the bottom surface 7. The swivel is also connected to a second fishing line 80 that reaches to a fishing pole (not shown). Another fishing line 86 connects the swivel to the hook 88. Presumably, bait 89 on the hook 88 is eaten by the fish 92 and the fish is caught on the barb of the hook 88 and brought to the surface. The plurality of facets 54 on the sinker 52 makes the sinker 52 virtually invisible to the target fish 92. Therefore, the target fish is not frightened by the sinker and decides to take the bait 89 and is hence caught.

Equivalent elements can be substituted for the ones set forth above such that they perform in substantially the same manner in substantially the same way for achieving substantially the same result. Although the described sinkers are embodied in specific forms and shapes, the present invention is not limited to any particular shape of sinker.

It is believed that the device of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A stealth sinker comprising:
a body member having a specific gravity greater than 1, the body member made from a material that reduces visibility to a target fish; and
a means for attaching a fishing line to the body member.

2. The stealth sinker of claim 1, wherein the material is colored glass.

3. The stealth sinker of claim 1, wherein the material is lead crystal glass.

4. The stealth sinker of claim 3, wherein the lead crystal glass is colored.

5. The stealth sinker of claim 1, wherein the means for attaching the fishing line is at least one eye.

6. The stealth sinker of claim 1, wherein the material comprises a core material and a reflective coating.

7. The stealth sinker of claim 6, wherein the core material is selected from the group comprising lead, steel, iron, copper, brass and stone.

8. The stealth sinker of claim 1, wherein the body member is in the shape of an inverted pyramid and the means for attaching the fishing line is an eyelet affixed to a base of the inverted pyramid.

9. The stealth sinker of claim 1, wherein the body member is in the shape of an egg and the means for attaching the fishing line is two eyelets affixed at opposite ends of the body member.

10. The stealth sinker of claim 1, wherein the body member is in the shape of a tear-drop and the means for attaching the fishing line is an eye affixed formed at a top end of the body member.

11. A stealth sinker comprising:
a body member made from lead crystal glass, the lead crystal glass reduces visibility of the body member to a target fish; and
a means for attaching a fishing line to the body member.

12. The stealth sinker of claim 11, wherein the lead crystal glass has a smooth outer surface.

13. The stealth sinker of claim 11, wherein an outer surface of the lead crystal glass has a plurality of facets.

14. The stealth sinker of claim 11, wherein the lead crystal glass is colored.

15. The stealth sinker of claim 11, wherein the body member is in the shape of an egg and the means for attaching the fishing line is two eyelets affixed at opposite ends of the body member.

16. A stealth sinker comprising:
a body member having a core material and a reflective coating whereas the core material has a specific gravity greater than 1 and the coating is mirrored thereby the coating reduces visibility to a target fish; and
a means for attaching a fishing line to the body member.

17. The stealth sinker of claim 16, wherein the core material is selected from the group comprising lead, steel, iron, copper, brass and stone.

18. The stealth sinker of claim 17, wherein the body member is in the shape of an inverted pyramid and the means for attaching the fishing line is an eyelet affixed to a base of the inverted pyramid.

19. The stealth sinker of claim 17, wherein the body member is in the shape of an egg and the means for attaching the fishing line is two eyelets affixed at opposite ends of the body member.

20. The stealth sinker of claim 17, wherein the body member is in the shape of a tear-drop and the means for attaching the fishing line is an eye affixed formed at a top end of the body member.
